(19) United States
(12) Patent Application Publication
(10) Pub. No.: US 2019/0300270 A1
(43) Pub. Date: Oct. 3, 2019

(54) Garden chemical dispenser

(71) Applicant: James Kallina, EI Campo, TX (US)

(72) Inventor: James Kallina, EI Campo, TX (US)

(21) Appl. No.: 15/932,622

(22) Filed: Mar. 27, 2018

(51) Int. Cl. B65D 83/06; B67D 3/00

(52) U.S. Cl. CPC B65D 83/06; B67D 3/0093; B67D 3/0074

(57) ABSTRACT

A vertical chemical dispenser is disclosed for dispensing chemicals in the garden. The vertical chemical dispenser teaches a hollow tube having a distal end and a proximal end. A removable cap is positioned at the distal end of the hollow tube. A stand which includes a base is positioned at the proximal end of the hollow tube; and a conical connector is positioned between the distal end of the hollow tube and the stand. The stand can include a dispenser plate assembly.

A vertical chemical dispenser is disclosed for dispensing chemicals in the garden.

### BRIEF DESCRIPTION OF THE FIGURES

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

FIG. 1 is a front view of one embodiment of the chemical dispenser;

FIG. 2 is a front view of another embodiment of the chemical dispenser;

FIG. 3 is an overhead side perspective view of the inside of the cap of the chemical dispenser;

FIG. 4 is a perspective front overhead view of the rim for attachment of a safety cap;

FIG. 5 is a perspective overhead view of the complementary safety cap to the embodiment of FIG. 4;

FIG. 6 is a schematic front perspective view of the chemical dispenser;

FIG. 7 is a schematic front perspective view of another embodiment of the of the chemical dispenser;

FIG. 8 is an underside perspective view of a top plate of the dispenser plate assembly of the chemical dispenser;

FIG. 9 is an underside perspective view of the bottom plate of the dispenser plate assembly of the chemical dispenser;

FIG. 10 is front perspective view of another embodiment of the proximal end of the chemical dispenser;

FIG. 11 is an underside view of the dispenser plate assembly of the chemical dispenser;

FIG. 12 is a perspective view of the dispenser plate assembly of the chemical dispenser;

FIG. 13 is a perspective view of the underside of the dispenser plate assembly of the chemical dispenser;

FIG. 14 is a perspective view of the top of the dispenser plate assembly of the chemical dispenser;

FIG. 15 is a perspective view of the cap of the chemical dispenser secured by a combination lock;

FIG. 16 is a perspective view of the cap of the chemical dispenser secured by a key lock;

FIG. 17 is a perspective view of the cap at the proximal end of the stand;

FIG. 18 is a perspective view of the base and the conical connector;

FIG. 19 is a first side view of the base and the conical connector;

FIG. 20 is a rear view of the base and the conical connector;

FIG. 21 is a perspective rear view of the base and the conical connector;

FIG. 22 is a front view of the an embodiment of the chemical dispenser with handles;

FIG. 23 is a front view of another embodiment of the handle arrangement for the chemical dispsenser;

FIG. 24 is a front view of yet another embodiment of the handle arrangement for the chemical dispenser, with the springs of the handles extended; and

FIG. 25 is a front view of another embodiment of the tube section of the chemical dispenser.

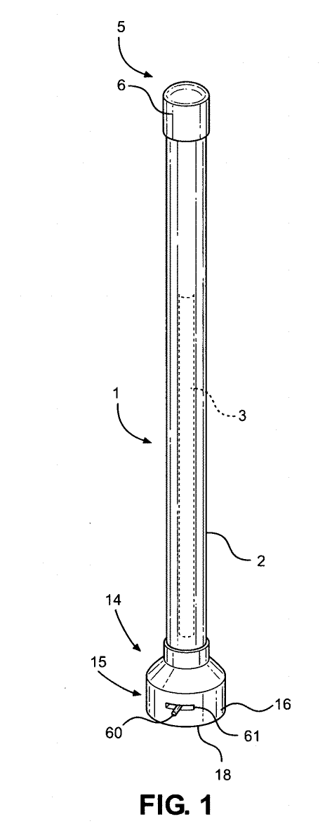

### DETAILED DESCRIPTION OF THE DISCLOSURE

The chemical dispenser 1 is used to disperse fertilizers, insecticides, herbicides, rodent repellant, deer repellant or any other chemical that one disperses in a yard or garden. In some cases, the chemical dispenser can be used inside a building to distribute, for example boric acid around a baseboard in a building to keep out ants.

The dispenser 1 comprises a tube 2. The tube 2 can be made of metal, plastic, or even wood or cardboard. It is important the tube 2 not decay or corrode as a result of chemical usage, or react with the chemicals within the tube 2. In one embodiment, the tube is made out of plastic. In another embodiment, the plastic is polyvinylchloride, known in the industry as PVC. In another embodiment, the tube 2 is a clear plastic. In another embodiment, the plastic material of the tube 2 is not transparent but there is a narrow window 3 running the length of the tube. In one embodiment, This window could range M width from about a ¼″ to about 3″. In one embodiment, the plastic window 3, which can be transparent or translucent, can be affixed on the inside the tube 2. In another embodiment, the window is secured within a longitudinal opening of the tube 2.

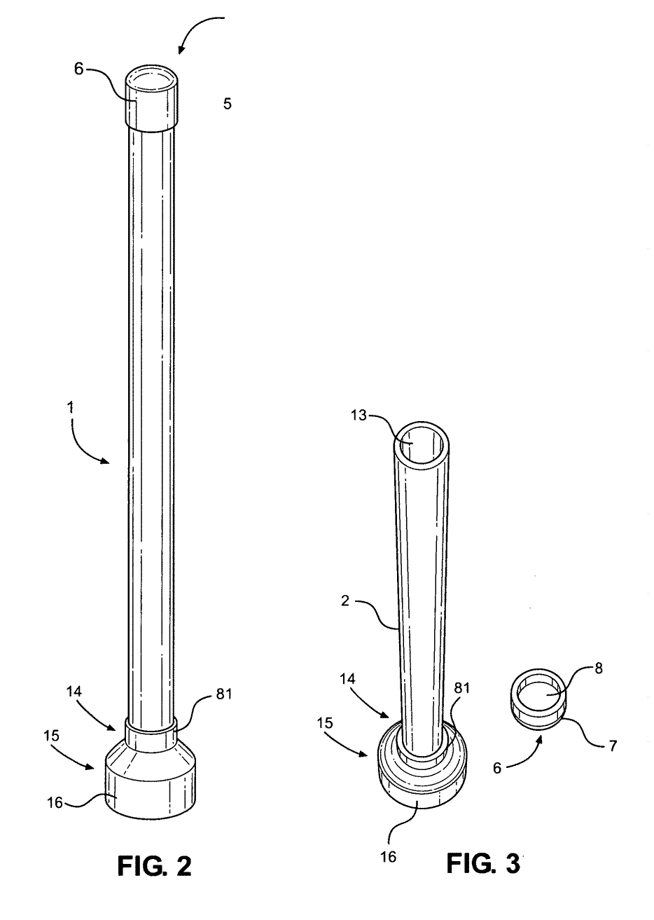

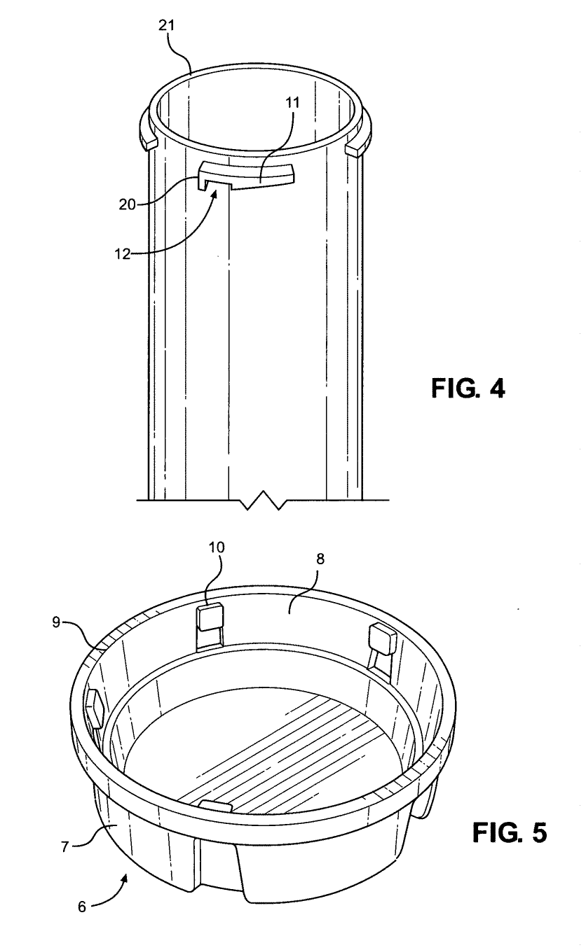

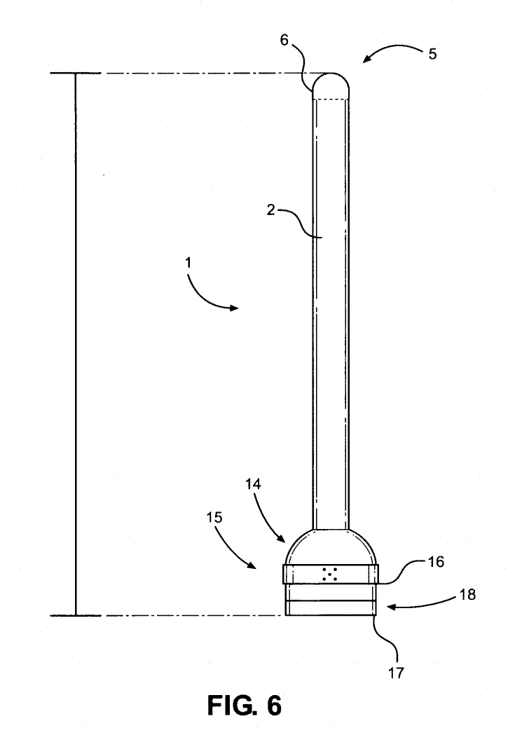

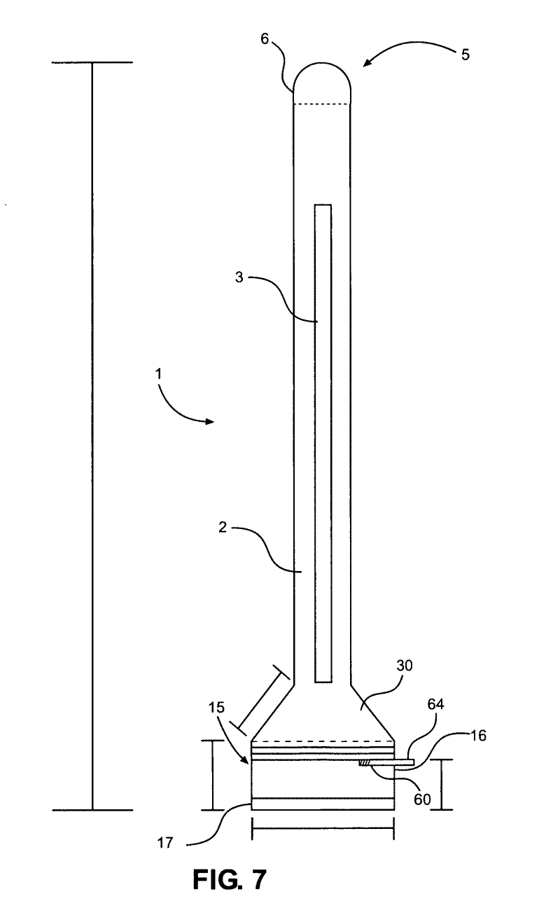

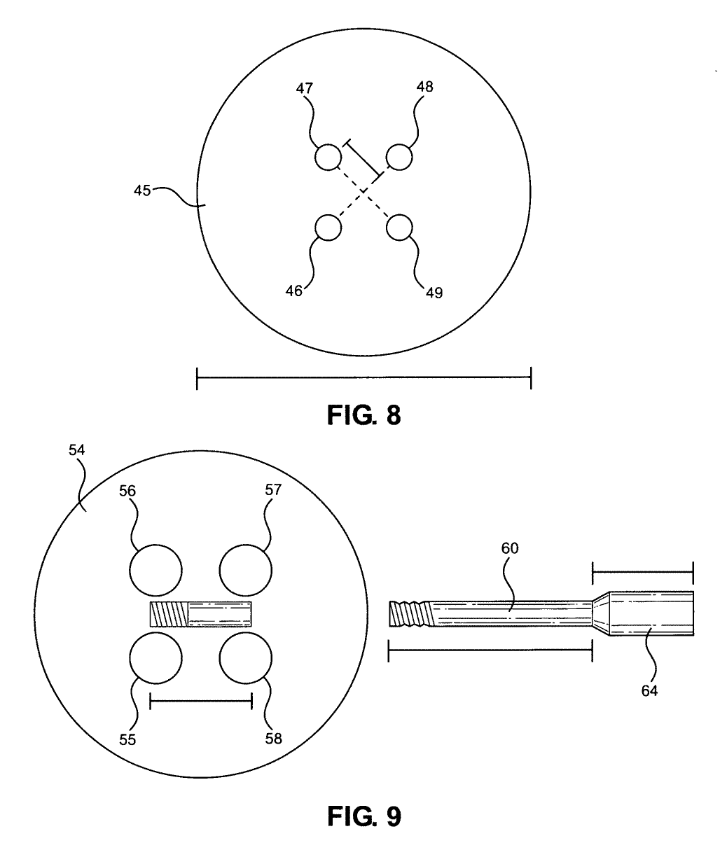

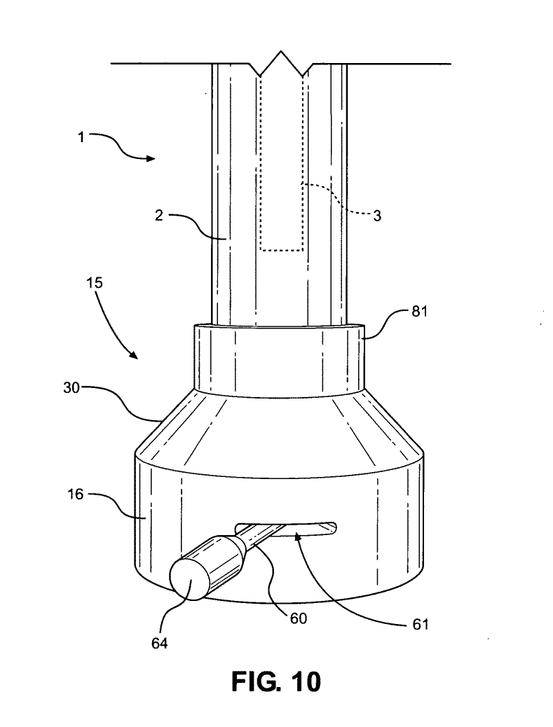

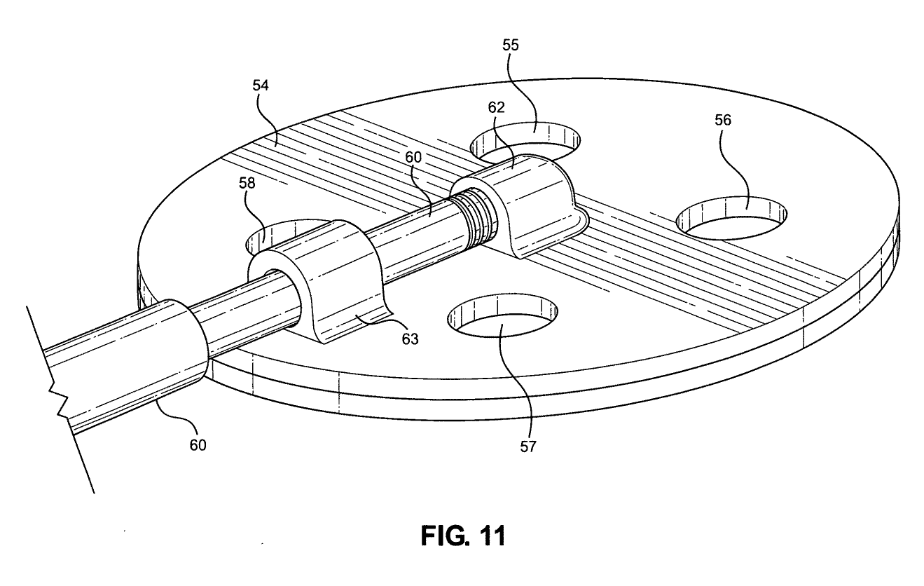

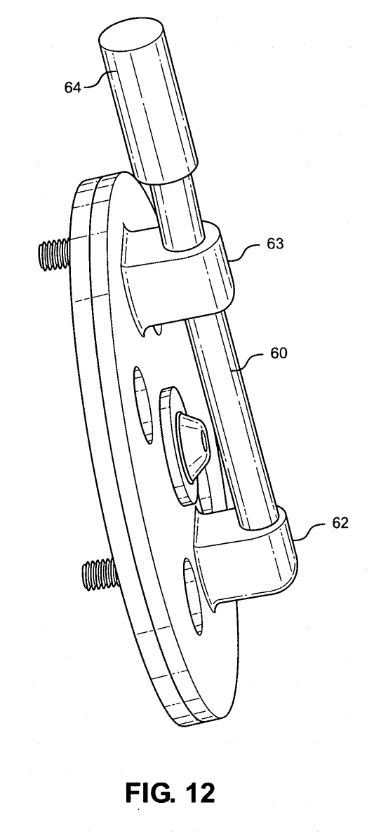

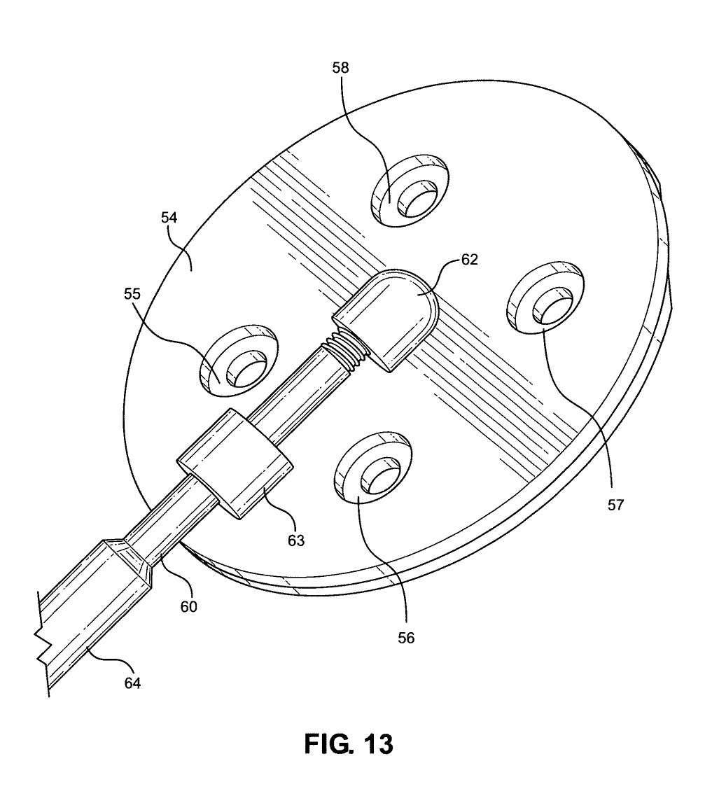

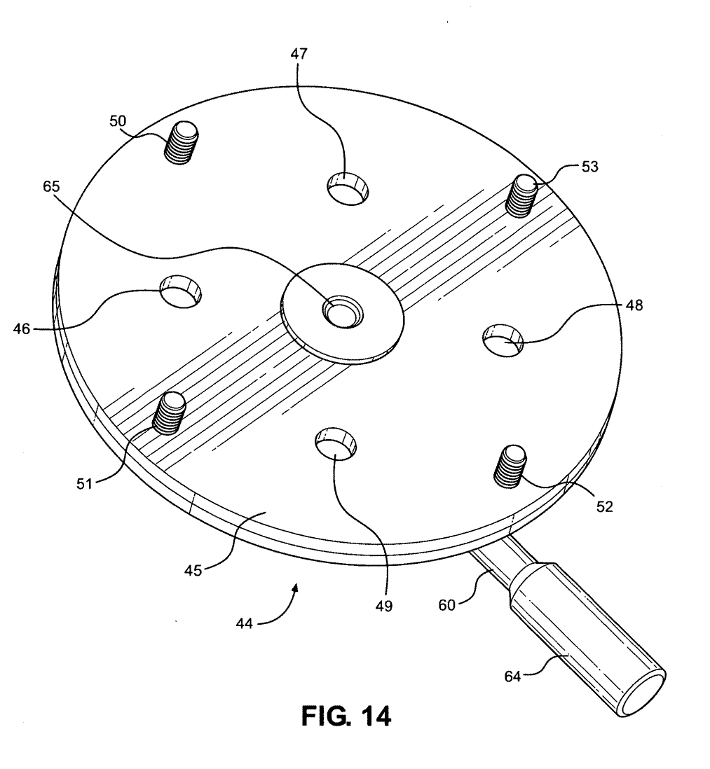

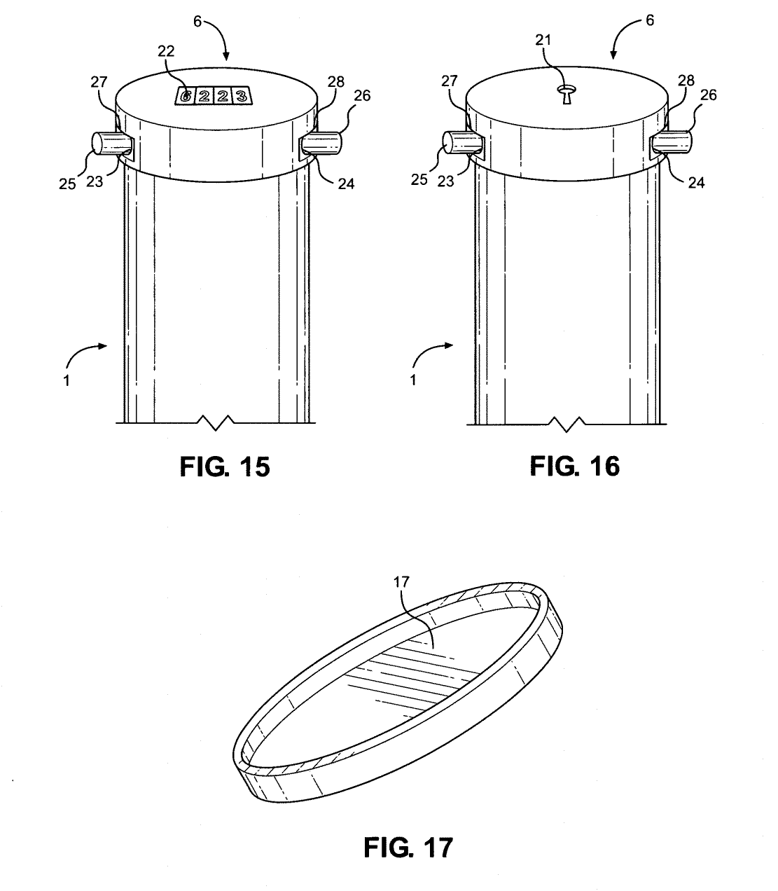

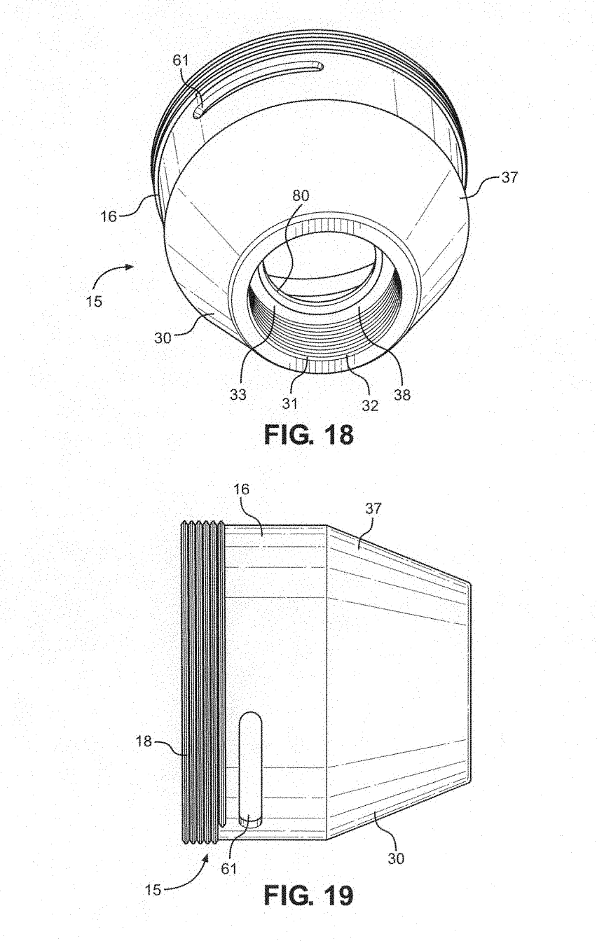

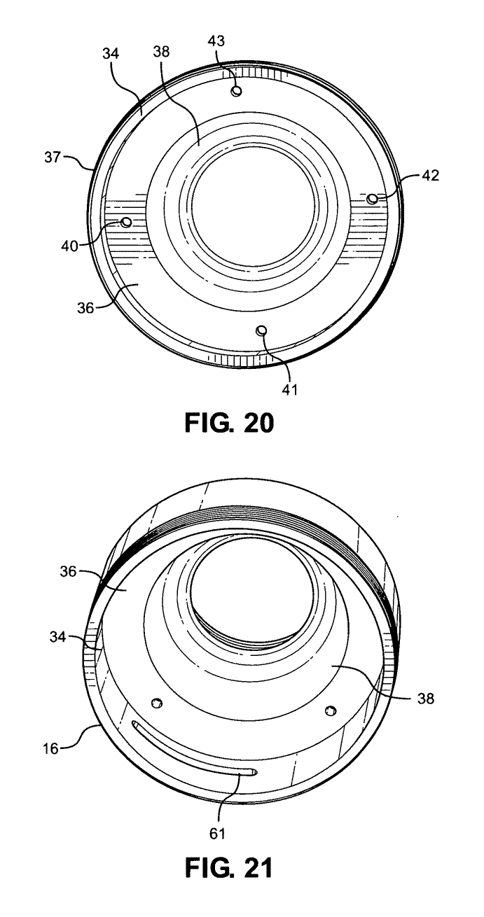

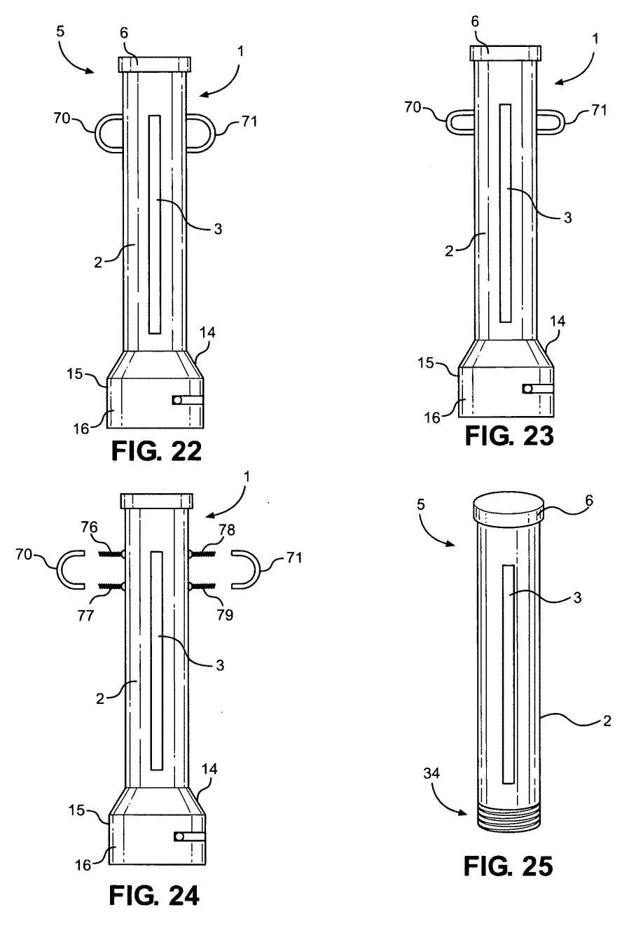

FIG. 2 is another embodiment for the shape of the chemical dispenser 1.

In one embodiment, the tube is transparent. In another embodiment, the tube is translucent. In another embodiment, the tube is opaque.

The distal end 5 of the dispenser 1 comprises a cap 6 which fits over opening 13, through which the fertilizer, insecticide, or herbicide is poured into the tube 2. As shown in FIG. 5, the cap 6 has an outside 7 and an inside 8. In one embodiment, the cap 6 is a safety cap to help prevent children from accessing the contents of the dispenser. In one embodiment, around and on the inside of the rim 9 are a plurality of small squares blocks 10. On the outside 10 of the distal end of the tube 2 are a plurality of block receptor traps 20. As shown, the block receptor traps 20 comprise downward pointing right triangular structures 11 with a square 12 “cut out” of the hypotenuse complementary to the small square blocks 10. The right triangular structures 11 are positioned far enough down from the tube rim 21 so that the cap fits comfortably over the opening 13. The cap 6 can be roundish or it can be flat.

It should be noted that any number of child safety cap locking mechanisms can be used known in the state of the art. Furthermore, in another embodiment, a key lock 21 can be used to lock the cap 6 as well as a combination lock 22 built into the cap . Openings 23, 24 positioned on either side of the cap allows a bolt 25, 26 to pass through the openings 27, 28 of the tube 2.

The dispenser 1 ranges in length from 25″ to 48″ long. In another embodiment, the length is from about 25″ to about 40″ and in another embodiment, the dispenser 1 is from about 29″ to about 36″. In one embodiment, the dispenser 1 is 31.5″ long. In one embodiment, the inside of the width of the dispenser 1 ranges from about 1″ to about 4″. In another embodiment, the tube 2 is from about 1″ to about 2″ wide on the inside and in another embodiment, the tube is about 1½ wide from inside wall to inside wall. The walls 16 of the tube range in width from about 0.04 inches to about 0.12 inches in thickness, depending on the material used. In another embodiment, the width of the walls 16 is about 0.1 inch. It should be noted that the figures and dimensions may vary from those given in the disclosure.

At the proximal end 14 of the dispenser 1 is a stand 15. In one embodiment, the stand 15 has a base 16 at its proximal end which is at least twice as wide as the width of the tube 2. In one embodiment the width of the base 16 measures between about 2″ and 8″. In another embodiment, the base 16 is between about 2.5 and 5″ and in another embodiment, the width of the base 16 is between about 3″ and about 4″ and in another embodiment, the base 16 is about 3.50″ inches in width.

In one embodiment, there is an end cap 17 that fits over the proximal end 18 of the base. In one embodiment, the end cap 17 is threaded and can be screwed onto a the proximal end 18 of the base 16, which can be also threaded. In another embodiment, the end cap 17 fits over the proximal end 18.

In one embodiment, the stand 15 has two sections. At its proximal end is the base 16. In one embodiment, the other section of the stand 15 comprises a conical connector 30 which connects the base 16 with the tube 2. In one embodiment, the stand 15 is threaded 31 at the distal end 32 of the conical connector 30, and the proximal end of the tube 2 is threaded 34, with the conical connector 30 being threaded on to the tube 2. In one embodiment, a rim 80 against which the proximal end of the tube 2 rests, is positioned at the proximal end 33 of the conical connector.

In yet another embodiment, there is an optional ring 81 integral with the conical connector

In another embodiment, the stand 15 is continuously integral with the tube 2. In yet another embodiment, the stand 15 is welded onto the tube 2. In one embodiment, the conical connector 30 is continuously integral with the base 16. In another embodiment the conical connector 30 and the base 16 are threaded together. In yet another embodiment, the conical connector 30 and the base 16 are welded together.

The width between the outside wall 37 of the conical connector wall 39 and the inside wall 38 of the conical connector wall 39 is less than the inside diameter of the base 16. In one embodiment, the space between the outside wall 37 and the inside wall of the conical connector can range from about ⅛ of an inch to about ¾ of an inch, with amounts lesser or greater than these figures possible as well. It should be noted that if in fact the outside wall 37 and the inside wall 38 of the conical connector are two separate walls of the conical connector 30. The basic construction elements of the chemical dispenser are not affected.

The height, length, and width of the stand, 15, the conical connector 30, the angle of the conical connector 30, and the base 16 may vary, as long as all three serve their function. In one embodiment, there is a 3:4 ratio of the lengths of the sides of the conical connector 30 and the base 16, and there is a ratio of roughly 0.4 to 0.6 of the length (or height) of the base to the width of the proximal end of the base. In another embodiment, this ratio is 0.4 to 0.5. In another embodiment, the length of the side or wall of the conical connector 30 is 1.2″, the height of the base 16, the width of the base is 3.5″ and the tube from the joinder of the conical connector 30 to the proximal end of the cap is 28.5 inches.

In one embodiment, a collar 36 is positioned at the proximal end of the conical connector 30 is connected to the base 16. Specifically, the collar 36 connects the proximal perimeter of outside wall 37 with the proximal perimeter of the inside wall 38 of the conical connector 30 along their proximal perimeters. In one embodiment, there are four screw holes 40, 41, 42, 43 drilled or molded into or through collar 36. In one embodiment, the holes are used to support a dispenser plate assembly 44, or more specifically, the top plate 45 of the dispenser plate assembly. There could be as few as two holes or there could be five or more holes.

It should be noted that the collar 36 and the base 16 can be made of metal or plastic.

In another embodiment, the collar 36 is integral with the perimeter of the proximal end of the outside wall 37 of the conical connector with the proximal end of the perimeter of the inside wall 38 of the conical connector 30. In another embodiment, the conical connector 30 is comprised of one solid piece of material, and the collar 36 is completely integrated with the conical connector 30.

A dispenser plate assembly 44 is used to adjust the flow and distribution of the chemical(s) being dispersed. In one embodiment, the top plate 45 comprises at least two distribution holes, and in another embodiment there are four distribution holes 46, 47, 48, 49, through which the chemicals being distributed will fall. In another embodiment, there could be less than four distribution holes, and in yet another embodiment, there could be more than four distribution holes through the top plate 45.

In the embodiment shown, there are four screws 50, 51, 52, 53 threaded from and through the underside of the top plate 45. These screws 50, 51, 52, 53 can be screwed into the holes 40, 41, 42, 43 to secure the top plate 45 into the collar 36. In alternative embodiments, there may be fewer screws or a greater number of screws.

There could be other means for attachment of the top plate 45. In one embodiment, the top plate 45 is glued to beneath the collar 36. In another embodiment, the top plate 45 is snapped into place between two plastic or metal lips (not shown).

A rotatable bottom plate 54 is centrally connected to the top plate 45 by a centrally located rivet. In alternative embodiments, other means known in the art, including screws, snap pegs, etc can be used to connect the two plates together. The rotatable bottom plate 54 also has four distribution holes 55, 56, 57, 58. In one embodiment, these distribution holes 55, 56, 57, 58 are larger than distribution holes 46, 47, 48, 49 in the top plate 45. In one embodiment, distribution holes 55, 56, 57, 58 of the bottom 54 plate have twice the diameter of distribution holes 46, 47, 48, 49 of the top plate 45. In one embodiment, the distribution holes 55, 56, 57, 58 of the bottom plate 54 are 0.5 inches in diameter, while holes 46, 47, 48, 49 in the top plate 45 are 0.25 inches in diameter. In another embodiment, the size of the holes can vary, as well as the ratio of sizes of the holes. In an alternative embodiment, the holes in the top plate 45 are larger than the holes in the bottom plate 54 .

A lever 60, which fits through a lever opening 61 and has a knob 64 positioned at the distal end of said lever, is affixed to the underside of the bottom plate 54. In one embodiment, the lever 60 is attached to the underside of the bottom plate 54 by a threaded bracket 62, supported by a second bracket 63, with both brackets being attached to the underside of the rotatable bottom plate 54. Movement of the lever from side to side allows the bottom plate 54 to parallelally rotate about the underside of the top plate 45. . This moves the positions of holes 55, 56, 57, 58 in relation to holes 46, 47, 48, 49 thereby either increasing or decreasing the flow of chemicals, or virtually preventing the flow of chemicals altogether.

In another embodiment, handles 70, 71 are positioned on either side of the tube 2. In one embodiment, handles 70, 71 are perpendicular to the tube 2. In another embodiment, the handles 70, 71 are positioned along the length of the tube.

In one embodiment, the handles are glued to the tube 2. In another embodiment, the handles are attached by screws (not shown). In another embodiment, the handles 70, 71 are attached by glue. In yet another embodiment, the handles 70, 71 are attached by springs 72, 73, 74, 75, which are attached by mounts 76, 77, 78, 79 that are either attached to or integral with the tube 2. In another embodiment, there is one handle that circumvents the tube, and is connected to the tube by the means described supra. When attached by springs, the tube can be shaken up and down with either one or two hands.

Although the present disclosure has been described with reference to the preferred embodiment be made without departing from the scope of the present disclosure which is intended to be defined by the appended claims differing from the type described above.

What is claimed is:

1) A garden chemical dispenser comprising:
a) a hollow tube, said hollow tube comprising:
i)a distal end into which a chemical powder or granule is poured; and
ii)a proximal end from which said chemical power or granule exits;
b) a removable cap positioned at the distal end of the hollow tube
c) a stand comprising a base positioned at the proximal end of the hollow tube;
d) a conical connector positioned between the distal end of the hollow tube and the stand;
e) a dispenser plate assembly, said dispenser plate assembly comprising:
a) a top plate comprising a plurality of distribution holes;
b) a bottom plate comprising a plurality of distribution holes, said bottom plate rotatable in relation to said top plate,
said top plate and said bottom plate positioned at the point wherein said bottom plate is rotatable connected at its center point to a center of the top plate;
f) a collar positioned within the hollow tube at the distal end of said conical connector, said top plate connected to an underside of said collar; and
g) a lever projecting through an opening in the stand at a first end of the lever, with said lever being connected to said bottom plate at a second end of said lever.

2) The garden chemical dispenser of claim 1, wherein the tube is comprised of a material selected from group consisting of metal, plastic, wood, and cardboard.

3) The garden chemical dispenser of claim 1, wherein the tube is selected from the group consisting of transparent, translucent, and opaque.

4) The garden chemical dispenser of claim 1, further comprising a window positioned longitudinally within the tube.

5) The garden chemical dispenser of claim 1, further comprising a safety lock to secure said cap to said distal end of said tube.

6) The garden chemical dispenser of claim 1, wherein said cap is a child's safety cap.

7) The garden chemical dispenser of claim 5, wherein said safety lock is a combination lock.

8) The garden chemical dispenser of claim 5, wherein said safety lock is a key lock.

9) (The garden chemical dispenser of claim 1, further comprising an end cap to a proximal end of the stand.

10) (canceled)

11) (canceled)

12) (canceled)

13) The garden chemical dispenser of claim 10, wherein said distribution holes of said top plate are smaller than the distribution holes of said bottom plate.

14) The garden chemical dispenser of claim 10, wherein said distribution holes of said top plate are larger than the distribution holes of said bottom plate.

15) The garden chemical dispenser of claim 10, wherein said distribution holes of said top plate are the same size as the distribution holes of said bottom plate.

16) The garden chemical dispenser of claim 1, further comprising at least two handles, each of said two handles positioned on the opposite side of said tube.
